(19) United States
(12) Patent Application Publication
(10) Pub. No.: US 2026/0084562 A1
(43) Pub. Date: Mar. 26, 2026

(54) Double-side magnetic wireless charger

(71) Applicant: Sijie Xiong, Shenzhen (CN)

(72) Inventor: Sijie Xiong, Shenzhen (CN)

(21) Appl. No.: 18/896,391

(22) Filed: Sep. 25, 2024

(51) Int. Cl. B60L 53/34; B60L 53/38

(52) U.S. Cl. CPC B60L 53/34; B60L 53/38

(57) ABSTRACT

The application relates to vehicle-mounted charging equipment, specifically describes a double-side magnetic wireless charger. It includes a bottom shell, a middle shell, a circuit board, a charging induction coil, and an internal magnet. The middle shell is detachably placed above the bottom shell, with an internal magnet and charging induction coil inside. A panel is located at the upper end of the middle shell. Additionally, a notch on the side of the bottom shell contains a type-C charging socket, connected to the circuit board. A bottom magnet is positioned in the middle of the lower part of the bottom shell, while an internal magnet on the front side and a bottom magnet on the back side allow the charger to be attached to iron objects. This design enables the charger to be used in more scenarios and offers greater convenience.

### FIELD OF THE APPLICATION

The present application relates to vehicle charging equipment. More specifically, the present application relates to double-side magnetic wireless charger.

### BACKGROUND

The magnetic wireless charger for mobile phones is a convenient way to charge your phone without needing to plug it in. It uses magnetism to charge the phone, eliminating the need for a charging cable and making it easier to use compared to traditional plug-in chargers.

Most current magnetic wireless chargers for mobile phones require a connecting frame to be installed on other objects for support. However, the fixing methods used, such as fixed clip or bolt fixing, are not convenient and can only be used on relatively narrow objects. This makes it difficult to attach the chargers to wider objects.

Therefore, a magnetic wireless charger with double-sided design is created for easy attachment to an object.

### SUMMARY

The technical problem to be solved by the present application is to address the shortcomings of the aforementioned technology and introduce a double-sided magnetic wireless charger.

To address the technical issues mentioned above, the present application offers a double-side magnetic wireless charger. This charger includes a bottom shell, a middle shell, a circuit board, a charging induction coil, and an internal magnet. The middle shell can be detached from the bottom shell, and it contains an internal magnet and a charging induction coil. The circuit board is positioned between the bottom shell and the middle shell.

The upper end of the middle shell is provided with a panel.

The side of the bottom shell is provided with a notch, and a type-c charging socket is provided in the notch. The tail of the type-c charging socket is connected to the circuit board.

A bottom magnet is arranged in the middle of the lower part of the bottom shell.

In an embodiment, the middle part of the upper end of the middle shell is provided with an inner mounting slot, and the charging induction coil is arranged in the inner mounting slot.

In an embodiment, the upper end of the middle shell is provided with an outer mounting slot, and the internal magnet is arranged in the outer mounting slot.

In an embodiment, the bottom of the bottom shell is provided with a plurality of internal screw hole mounting columns, and the middle shell and the circuit board are threadedly connected by bolts and the internal screw hole mounting columns.

In an embodiment, the bottom of the bottom shell is provided with a lower mounting slot penetrating into the interior of the bottom shell, the bottom magnet is arranged in the lower mounting slot, a baffle is provided at the lower part of the lower mounting slot, the baffle cooperates with the bottom magnet to limit the bottom magnet, and the upper end of the bottom magnet abuts against the lower end of the circuit board.

In an embodiment, the upper end of the bottom shell is provided with a connection slot, the lower end of the middle shell is provided with a connecting plate, and the middle shell is connected and matched with the connection slot through the connecting plate.

The present application offers several advantages over prior art. The front of the double-sided magnetic wireless charger features an internal magnet that can be used to hold the mobile phone in place. The back is equipped with a bottom magnet, allowing the charger to be attached to iron objects. This feature expands its usability in various scenarios, making it more convenient to use and also easier to secure in place.

### BRIEF DESCRIPTION OF THE DRAWINGS

The technology may be more completely understood in connection with the following drawings, in which:

FIG. 1 is a side view of a double-side magnetic wireless charger, according to an embodiment;

FIG. 2 is a top perspective view of a double-side magnetic wireless charger, according to an embodiment;

FIG. 3 is a bottom perspective view of a double-side magnetic wireless charger, according to an embodiment;

FIG. 4 is a structural diagram of the double-sided magnetic wireless charger in the disassembled state, according to an embodiment;

FIG. 5 is a sectional view of A from FIG. 1, according to an embodiment;

FIG. 6 is an enlarged view of B from FIG. 5, according to an embodiment.

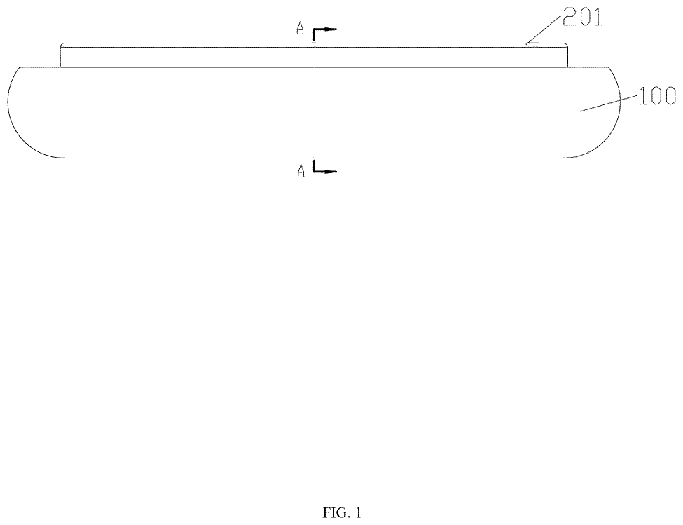

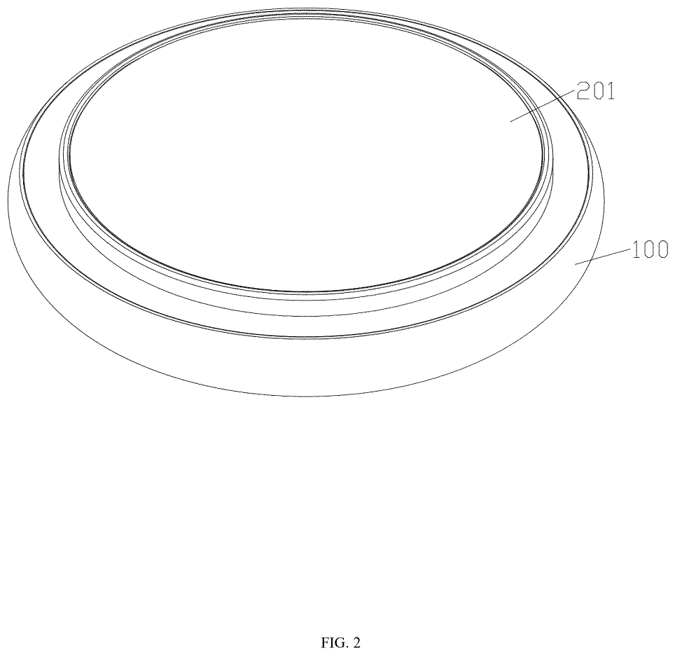

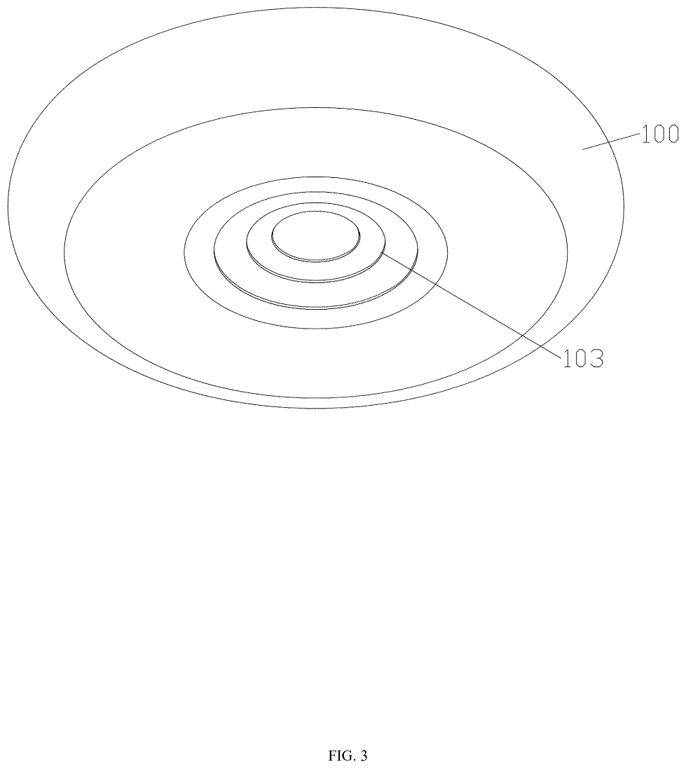

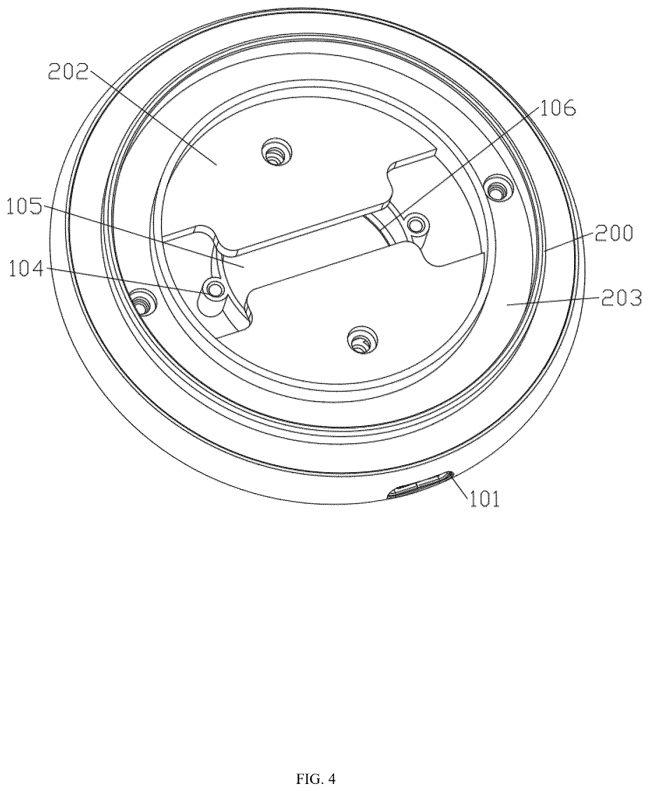

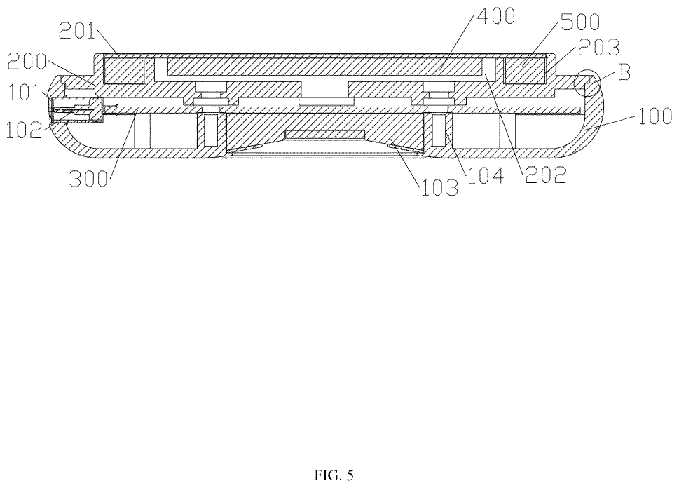

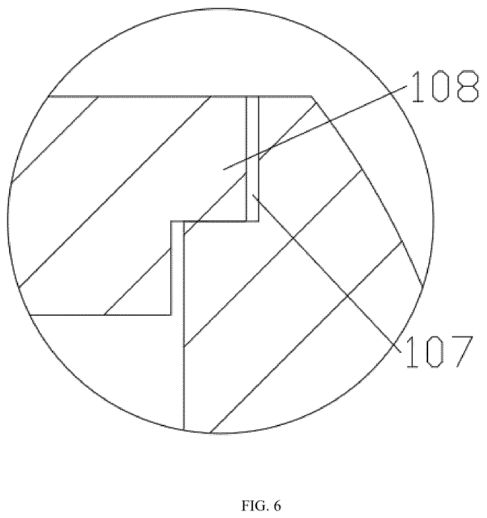

As show in FIGS. 1-6:
100. bottom shell
101. notch
102. type-c charging socket
103. bottom magnet
104. inner screw hole mounting column
105. lower mounting slot
106. baffle
107. connection slot
108. connecting plate
200. middle shell
201. panel
202. inner mounting slot
203. outer mounting slot
300. circuit board
400. charging induction coil
500. internal magnet

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION OF EMBODIMENTS

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

As shown in FIGS. 1-6, a double-side magnetic wireless charger, comprising a bottom shell, a middle shell, a circuit board, a charging induction coil and an internal magnet. The middle shell 200 is detachably arranged above the bottom shell 100. An internal magnet 500 is arranged inside the middle shell 200. The internal magnet 500 and the magnet on the device to be charged attract each other to achieve rapid alignment and stable connection, thereby improving charging efficiency. The internal magnet 500 is in a circular shape and can also be arranged in different shapes according to usage requirements. A charging induction coil 400 is arranged inside the middle shell 200. The coil is responsible for generating a magnetic field and interacting with a receiving coil inside the device to be charged to achieve wireless charging. The circuit board is arranged between the bottom shell and the middle shell, and is the core control component of the wireless charger, responsible for functions such as charging control. The upper end of the middle shell 200 is provided with a panel 201, which is the part that the user directly contacts with the charger. The panel 201 can be aesthetically designed or functionally expanded as needed.

The bottom shell 100 has a notch 101 on the side, and a type-c charging socket 102 is disposed of in the notch 101 to receive an external power source. The type-c charging socket 102 tail is welded to the circuit board 300.

The bottom of the bottom shell 100 is provided with a lower mounting slot 105 that penetrates the interior of the bottom shell 100. The bottom magnet 103 is arranged in the lower mounting slot 105. A baffle 106 is provided at the lower part of the lower mounting slot 105. The baffle 106 cooperates with the bottom magnet 103 to limit the bottom magnet 103 and prevent the bottom magnet 103 from sliding out of the lower mounting slot 105. The upper end of the bottom magnet 103 abuts against the lower end of the circuit board 300.

The middle portion of the upper end of the middle shell 200 is provided with an inner mounting slot 202, and the charging induction coil 400 is arranged in the inner mounting slot 202.

The upper end of the middle shell 200 is provided with an outer mounting slot 203, and the internal magnet 500 is arranged in the outer mounting slot 203.

The bottom of the bottom shell 100 is provided with a plurality of internal screw hole mounting columns 104, and the middle shell 200 and the circuit board 300 are threadedly connected by bolts and the internal screw hole mounting columns 104 to firmly fix the middle shell 200 and the circuit board 300 on the bottom shell 100.

The upper end of the bottom shell 100 is provided with a connection slot 107, and the lower end of the middle shell 200 is provided with a connecting plate 108. The middle shell 200 is connected and matched with the connection slot 107 through the connecting plate 108 to achieve a stable connection between the two.

When in use, the type-c charging plug of the charging cable can be inserted into the type-c charging socket 102. For iron objects, the charger can be adsorbed on the iron object through the bottom magnet 103, for example, it can be adsorbed on fitness equipment, etc. On the one hand, it can be easily fixed, and then the mobile phone is placed on panel 201, and the mobile phone will be adsorbed on the charger, so that it can be charged, and you can watch videos or observe data while exercising.

When fixed to a non-iron object, it can be installed through other charger-fixing frames, etc.

1. A double-side magnetic wireless charger, comprising a bottom shell, a middle shell, a circuit board, a charging induction coil, and an internal magnet; wherein the middle shell is detachably arranged above the bottom shell and contains an internal magnet and a charging induction coil;
wherein the circuit board is positioned between the bottom shell and the middle shell;
wherein the upper end of the middle shell is provided with a panel;
wherein the side of the bottom shell is provided with a notch, and a type-c charging socket is provided in the notch; wherein the tail of the type-c charging socket is connected to the circuit board;
wherein a bottom magnet is arranged in the middle of the lower part of the bottom shell.

2. The double-side magnetic wireless charger of claim 1, wherein the middle part of the upper end of the middle shell is provided with an inner mounting slot, and the charging induction coil is arranged in the inner mounting slot.

3. The double-side magnetic wireless charger of claim 1, wherein the upper end of the middle shell is provided with an outer mounting slot, and the internal magnet is arranged in the outer mounting slot.

4. The double-side magnetic wireless charger of claim 1, wherein the bottom of the bottom shell is provided with a plurality of inner screw hole mounting columns, and the middle shell and the circuit board are threadedly connected by bolts and the inner screw hole mounting columns.

5. The double-side magnetic wireless charger of claim 1, wherein the bottom of the bottom shell is provided with a lower mounting slot penetrating into the interior of the bottom shell, the bottom magnet is arranged in the lower mounting slot, a baffle is provided at the lower part of the lower mounting slot, the baffle cooperates with the bottom magnet to limit the bottom magnet, and the upper end of the bottom magnet abuts against the lower end of the circuit board.

6. The double-side magnetic wireless charger of claim 1, wherein the upper end of the bottom shell is provided with a connection slot, the lower end of the middle shell is provided with a connecting plate, and the middle shell is connected and matched with the connection slot through the connecting plate.
